(19) United States
(12) Patent Application Publication
(10) Pub. No.: US 2025/0373728 A1
(43) Pub. Date: Dec. 4, 2025

(54) SYSTEM FOR ENHANCED EMERGENCY CALLBACK

(71) Applicant: T-Mobile USA, Inc., Bellevue, WA (US)

(72) Inventors: Dinko Georgiev Dinkov, Kirkland, WA (US); Homer Nicolas Filart, Renton, WA (US); William Michael Hooker, Bellevue, WA (US)

(21) Appl. No.: 18/733,020

(22) Filed: Jun. 4, 2024

(51) Int. Cl. H04M 3/51

(52) U.S. Cl. CPC H04M 3/5116; H04M 3/5158

(57) ABSTRACT

The system comprises a gateway node configured to receive a request from a public safety answering point. The request is configured to initiate an emergency callback session with a user device in response to an error occurring in an emergency session between the user device and the public safety answering point. The system also includes a home network node configured to provide, upon an identity of the public safety answering point being verified, verification information about the request and the public safety answering point to the user device. The system includes a module deployed on a user device, the module comprising at least one processor and at least one non-transitory memory storing instructions. The instructions, when executed by the at least one processor, cause the module to display the verification information about the request on a user interface of the user device.

### BACKGROUND

Caller identification (ID) is a telephone service available in analog and digital telephone systems, including Voice over Internet Protocol (VoIP), that transmits a caller's telephone number to the called party's telephone equipment when the call is being set up. The caller ID service may include the transmission of a name associated with the calling telephone number in a service called Calling Name Presentation (CNAM). The information received from the service is displayed on a telephone display screen, on a separately attached device, or on other displays, such as cable television sets when the same vendor provides telephone and television service.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 shows an example architecture that utilizes the identity of a public safety answering point (PSAP) to decide whether to provide preferential treatment of callbacks.

FIG. 4 illustrates a SHAKEN reference architecture for caller identity, resource-priority header (RPH), and priority signing and verification for a PSAP.

FIG. 5 illustrates a block diagram of an embodiment of the system for providing enhanced callback capabilities for emergency personnel.

FIG. 6 illustrates an example signaling flow in accordance with one or more embodiments of the present technology.

FIG. 7 illustrates an example display of a verified callback on a user device in accordance with one or more embodiments of the present technology.

FIG. 8 illustrates a flowchart of a process for emergency callbacks performed by the system.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for enhanced callback features for emergency services. Emergency services are contacted via a public safety answering point (PSAP). A PSAP, sometimes referred to as a public safety access point, is a type of call center where the public's telephone calls for first responders or emergency services (such as police, fire department, or emergency medical services/ambulance) are received and handled. The PSAP takes calls from any landline, mobile phone line, or Voice over Internet Protocol (VoIP) line. During a call with a PSAP, an originating caller can get disconnected from the PSAP, forcing the PSAP to initiate a callback to the originating caller. A callback occurs when the originator of a call is immediately called back in a second call as a response. Issues can arise during the callback that prevent the originating caller from receiving the callback. For example, the originating caller may not answer the callback due to the originating caller not recognizing the callback number, the callback may go straight to voicemail due to the originating caller making another telephone call, or the originating caller may be using a suspended device that is unable to receive telephone calls.

The disclosed technology provides a system that allows PSAPs to use enhanced callback features to reach the originating caller when a disconnection occurs. For example, the system provides enhanced caller identification (ID) using the Session Initiation Protocol (SIP) priority header and/or the encoded and signed Signature-based Handling of Asserted information using toKENS (SHAKEN) personal assertion token (PASSport) to provide additional information to the originating caller to identify the PSAP during an attempted callback. Enhanced caller ID uses the SIP P-Asserted Identity header to display the telephone number of an incoming call along with the name of the registered owner of the phone number on the originating caller's wireless device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

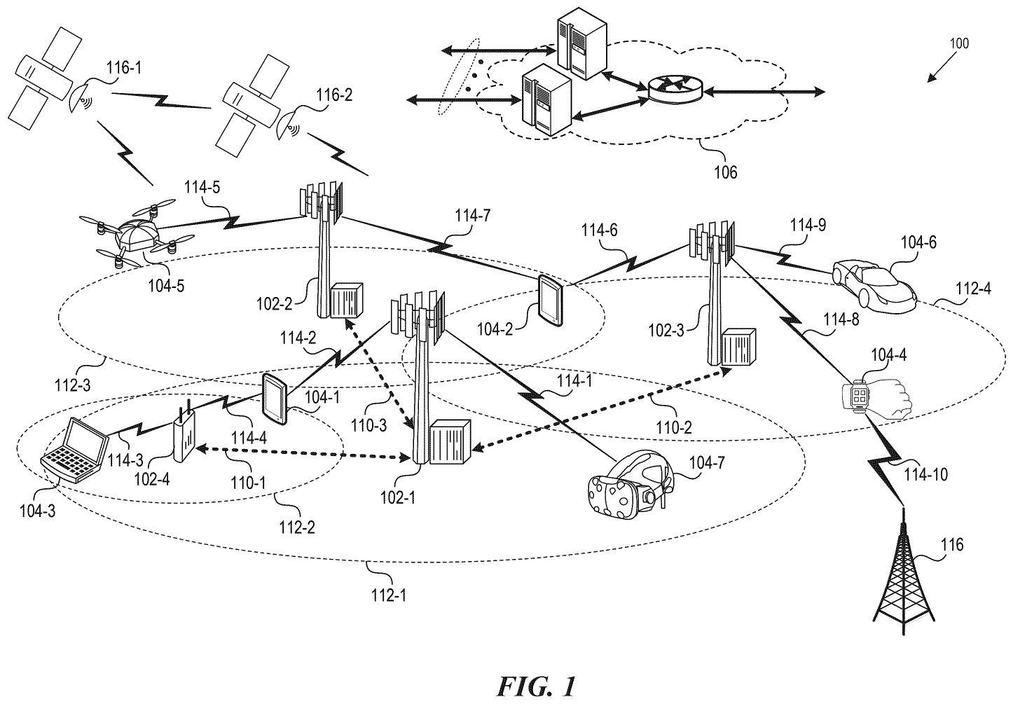

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

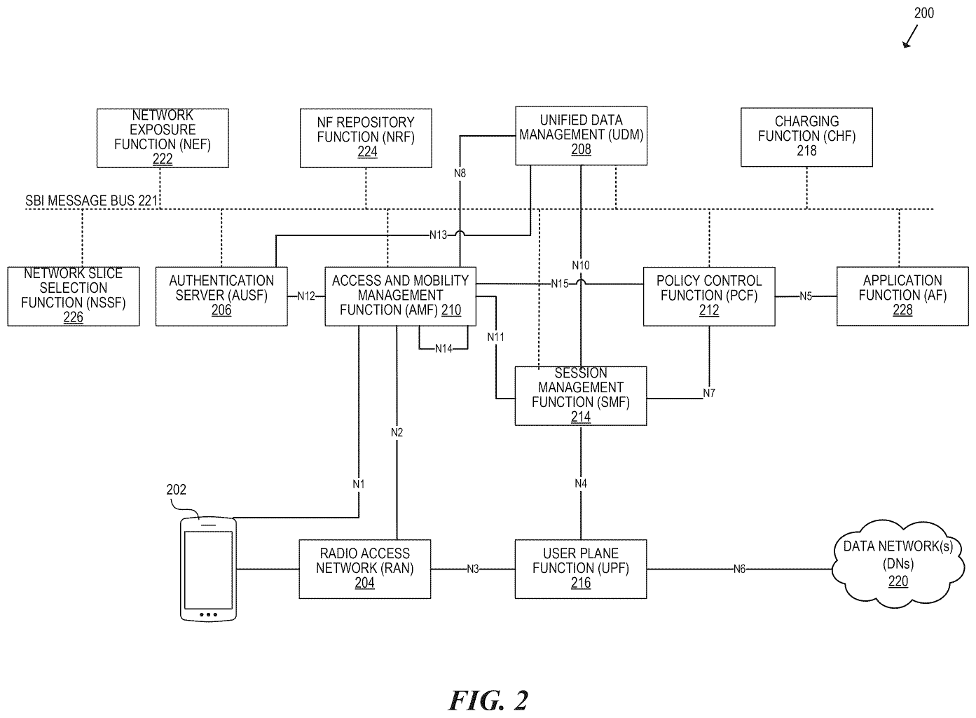

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### SIP PSAP Callback Verification

The Session Initiation Protocol (SIP) is a signaling protocol used for initiating, maintaining, and terminating communication sessions that include voice, video, and messaging applications. A priority header field of the SIP signaling indicates the urgency of a request as perceived by the client. For example, the header field can have values such as “non-urgent,” “normal,” “urgent,” or “emergency.” Additional values can be defined and used as well. Depending on local policies, SIP entities that receive the header field value within an initial request for a SIP session can apply PSAP callback-specific procedures for the session or request. When the SIP priority header is “psap-callback,” the PSAP callback allows marked calls to bypass deny lists and ignore call-forwarding procedures to notify the originating caller that the PSAP is calling.

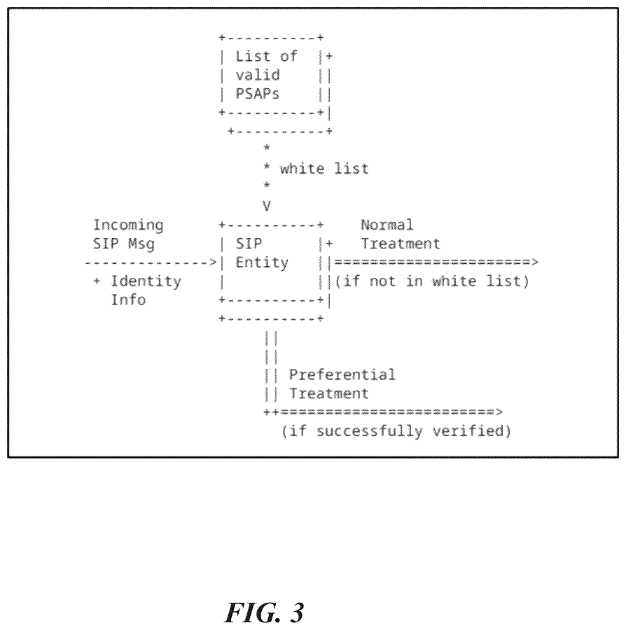

FIG. 3 shows an example architecture that utilizes the identity of the PSAP to decide whether preferential treatment of callbacks should be provided. To make this policy decision, the identity of the PSAP (e.g., calling party identity) is compared with a PSAP white list. For callback-specific procedures, the name of the registered owner of the phone number comes from a national phone database. Security concerns can arise due to caller identification (ID) spoofing. Spoofing is when a caller deliberately falsifies the information transmitted on a caller ID display to disguise their identity. Scammers often use neighbor spoofing, whereby an incoming call appears to be coming from a local number, or spoofing a number of a known or trusted company or government agency. A scammer can accomplish this by modifying the SIP P-asserted Identity header so that the callback appears to be originating from a reputable source, such as a PSAP.

The identity assurance in SIP can come in different forms via the SIP identity or the P-Asserted-Identity mechanism. The former technique relies on cryptographic assurance, and the latter relies on a chain of trust. Also, using Transport Layer Security (TLS) between neighboring SIP entities can provide useful identity information. Establishing a white list with PSAP identities may be operationally complex and dependent on the relationship between the emergency services operator and the VoIP provider. If there is a relationship between the VoIP provider and the PSAP operator, for example, when they are both operating in the same geographical region, then populating the white list is reasonably simple, and consequently, the identification of a PSAP callback is less problematic compared to the case where the two entities have never interacted directly with each other before. Ultimately, the VoIP provider has to verify whether the marked callback message came from a legitimate source. VoIP providers only give PSAP callbacks preferential treatment when the calling party identity of the PSAP is successfully matched against entries in the white list. When the PSAP callback cannot be verified, the VoIP provider must remove the PSAP callback marking in the SIP priority header and revert the callback to a regular call.

The Signature-based Handling of Asserted information using toKENS (SHAKEN) framework is a framework that is used to prevent spoofing and eliminate security concerns. The SHAKEN framework relies on the transmission of information via Session Initiation Protocol (SIP) messages. It can only operate on the internet protocol (IP) portions of a voice service provider's network (e.g., those portions served by network technology that can initiate, maintain, and terminate SIP calls). The SHAKEN framework assumes that the originating voice service provider attests to the caller's identity, and the terminating voice service provider verifies the identity of the originator of the message that contains the caller's identity. The SHAKEN framework defines three levels of attestation that reflect the ability of the originating network provider to vouch for the accuracy of the source of origin of the call. To provide enhanced callback features by combining enhanced caller ID with SHAKEN, the system uses a subscriber's, such as the originating caller's, home network to utilize the result from SHAKEN and the resource-priority header (RPH) personal assertion token (PASSport) verification to determine that the PSAP callback is a legitimate call and not a spoofed call. Based on the verification, the system uses the home network to insert a caller verification flag and enhanced caller ID information. The enhanced caller ID information can include the caller's name, call info, and the reason for calling to allow the originating caller to understand the importance of the PSAP callback.

After verification, the system can provide other enhanced callback features, for example, the suppression of telephony supplementary services such as call waiting, call holding, call forwarding, or barring of all incoming calls (BAIC) to prevent the PSAP call from being interrupted. Additionally, the system can provide logic to the originating caller's wireless device to temporarily suppress any new outgoing or incoming calls once the originating caller answers the PSAP callback. The system can also cause the originating caller's wireless device to ring or notify the originating caller when the originating caller is currently on a call instead of sending the PSAP callback straight to voicemail. The verification provided by SHAKEN allows the system to provide the enhanced callback features only to the PSAP without allowing other entities, such as hackers, scam artists, or other bad actors, to use the enhanced features and harm the originating caller.

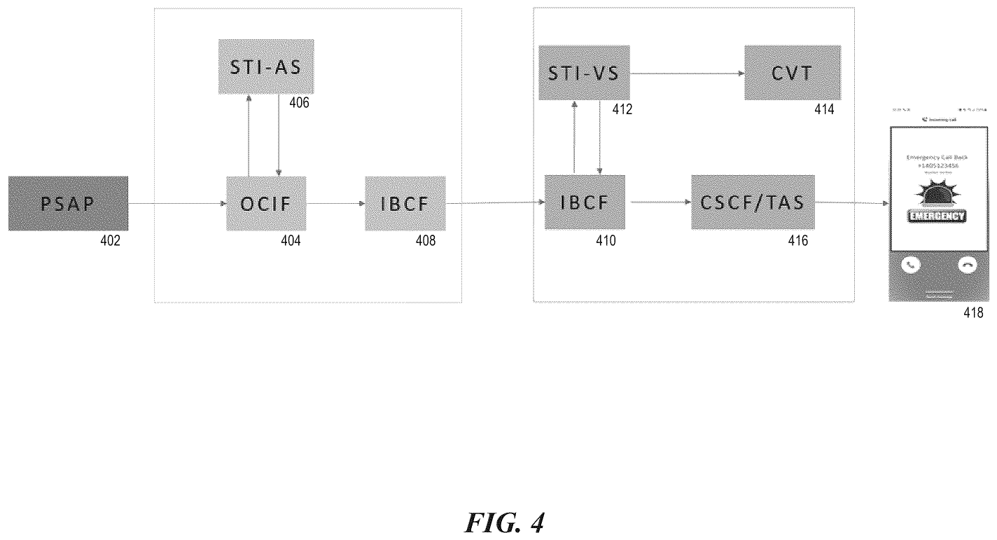

FIG. 4 illustrates a SHAKEN reference architecture for caller identity, RPH, and priority signing and verification for a PSAP 402. The PSAP 402 initiates a request for an emergency callback that includes the telephone number associated with the emergency caller to which the emergency callback is being directed, the telephone number of the PSAP 402 that is initiating the emergency callback, a value of “psap-callback” in the priority header field, and a value of “esnet.0” in the RPH field of the outgoing SIP signaling message. The SIP message is forwarded to the outbound call interface function (OCIF) 404. The OCIF 404 uses the telephone number of the emergency caller to determine the routing for the call. In this example, the call is destined for the emergency caller's IP-based home network. Before forwarding the call to the interconnected network, the OCIF 404 passes the SIP INVITE message to the Secure Telephone Identity Authentication Service (STI-AS) 406 for authenticating and signing the caller identity and the RPH and SIP priority header. The STI-AS 406 determines through service provider-specific means the legitimacy of the PSAP telephone number identity and RPH and priority header values included in the callback request. The STI-AS 406 is then responsible for signing the PASSporT and adding identity header fields and signatures corresponding to the caller identity and the RPH/priority header. The STI-AS 406 then adds an identity header field associated with the caller identity and an identity header field associated with the signed RPH/priority header to the SIP signaling message and passes it back to the OCIF 404. The OCIF 404 routes the callback call via the interconnection border control function (IBCF) 408 over the network-to-network interface to the emergency caller's home network.

Upon receiving the callback request, the IBCF 410 at the entry point of the emergency caller's home network initiates a verification request to the Secure Telephone Identity Verification Service (STI-VS) 412 that includes an identityHeader parameter associated with the caller identity and an identityHeaders parameter associated with the RPH/SIP priority header. The STI-VS 412 verifies the signatures in the identityHeader and identityHeaders parameters, which validates the caller identity and RPH/SIP priority header field content used when the STI-AS 406 signed the caller identity and RPH/SIP priority header content. The STI-VS 412 can send attestation flags sent by the originating network to perform a call validation treatment (CVT) 414 to determine whether the call can be authenticated. When a call is being authenticated, the verstate parameter can be updated as “TN validation passed” or “TN validation failed.” The STI-VS 412 returns a verification response containing a verstatValue parameter (associated with the caller identity) and a verstatPriority parameter (associated with the RPH/SIP priority header) to the IBCF 410, indicating the success or failure of the verification process. The IBCF 410 continues to process the callback call by passing the callback request, along with the verification results, to the CSCF 416, which passes it to the emergency caller's device 418.

### Enhanced Emergency Callback

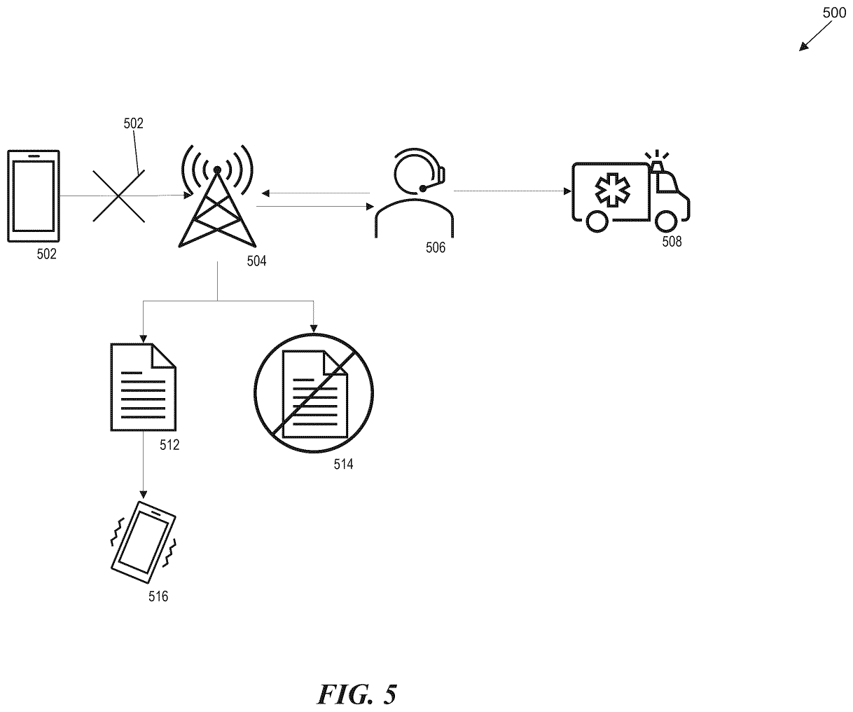

FIG. 5 illustrates a block diagram of an embodiment 500 of the system for providing enhanced callback capabilities for emergency personnel. An originating caller 502 contacts the PSAP 506 over the telecommunication network 504 when emergency services 508 are needed. The telecommunication network 504 operates using the IP to provide telephone services over the internet. Before the PSAP 506 deploys the emergency services 508, a disconnect occurs. A disconnect is when the call between the originating caller 502 and the PSAP 506 is dropped or disconnected. When the disconnect occurs, the PSAP 506 performs a callback over the telecommunication network 504 to attempt to re-establish the call with the originating caller 502.

When the callback is initiated, the system uses a SIP priority header of “psap-callback” to access advanced callback functionality. In one implementation, a gateway node is configured to receive a request from a PSAP, where the request is configured to initiate an emergency callback session with a user device in response to an error that occurred in an emergency session between the user device and the PSAP. To prevent spoofing, the system verifies the identity of the PSAP 506 using the SHAKEN framework. For example, by using SHAKEN, the system can verify the identity of the PSAP 506 to determine that the callback was initiated by the PSAP 506 and not by a scammer. In one implementation, the system determines, using the SHAKEN framework, that a PASSport 514 does not belong to the PSAP 506. The system does not verify the identity of the caller and removes “psap-callback” from the SIP priority header to prevent the unverified caller from accessing enhanced callback features 516. For example, when the SIP priority header is changed, the system causes the call to act like a typical telephone call without the enhanced callback features 516. In another implementation, the system using the home network of the originating caller 502 determines, using the SHAKEN framework, that a PASSport 512 belongs to the PSAP 506. The system verifies the caller, allowing the PSAP 506 to access the enhanced callback features 516.

In some embodiments, when the system has verified that the PSAP callback is legitimate, the system uses the home network of the originating caller 502 to provide enhanced caller ID and insert enhanced caller verification flags. Enhanced caller ID can include the name of the PSAP 506, the call info, a logo, and the reason the PSAP is calling. By providing the PSAP's name and reason for calling the originating caller, the originating caller 502 is more likely to answer the callback and understand the callback's importance. In one implementation, a module is deployed on a user device, wherein the module comprises at least one processor and at least one non-transitory memory storing instructions, which, when executed by the at least one processor, cause the module to display the verification information about the request on a user interface of the user device.

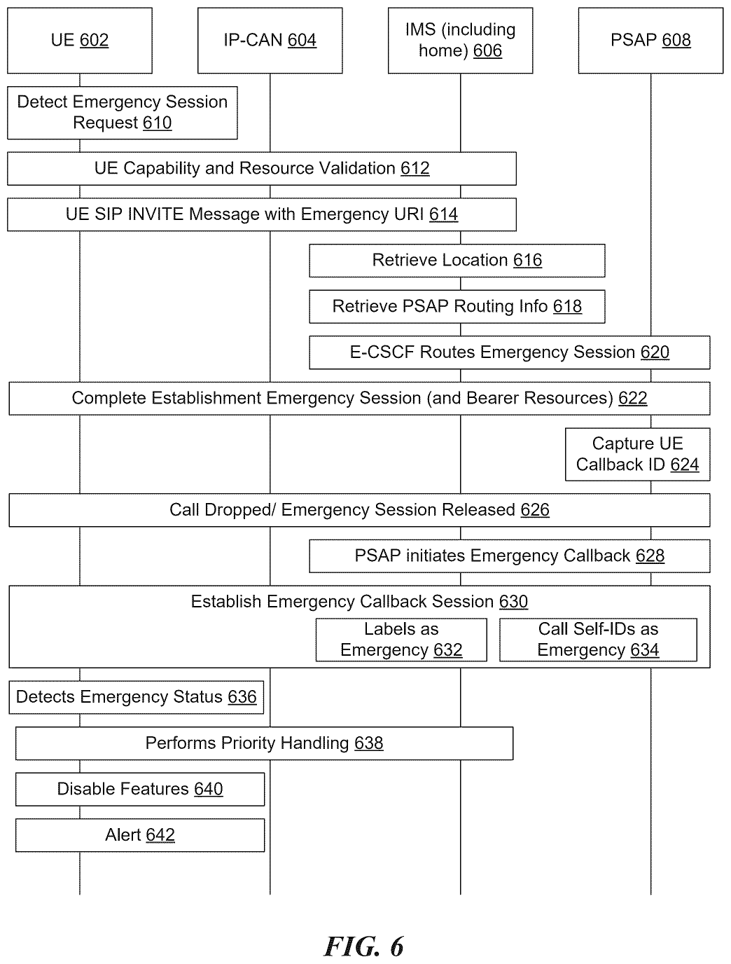

FIG. 6 illustrates an example signaling flow in accordance with one or more embodiments of the present technology. In FIG. 6, a methodology or sequence of operations 600 performed by a UE 602, IP-CAN 604, IMS network 606, and PSAP 608 for handling of emergency calls at the UE 602. In block 610, the UE detects the request as the establishment of an emergency session. For instance, PSAP 608 initiates a new call to the UE (e.g., PSAP Callback case), and the UE 602 can identify this call as an emergency-call based on the SIP header value (e.g., P-Asserted-Identity or priority). The header value can be inserted by the PSAP itself (or by some other network entity on behalf of the PSAP).

In the case that the UE 602 has insufficient resources or capabilities to establish an emergency call due to other ongoing sessions, then the UE should terminate the ongoing communication and release reserved bearer resources (block 612). In some instances, the UE 602 needs assistance or verification of location. To that end, the IMS network 606 can assist in emergency session establishment using the location retrieval function (LRF) or routing determination function (RDF) to retrieve location and routing information in response to the UE 602 initiating an emergency session request by sending a SIP INVITE message including an emergency uniform resource indicator (URI) (block 614). If required, the IMS network 606 can access the LRF to retrieve the UE's location (block 616). If required, the LRF invokes the RDF to determine the proper PSAP destination (block 618). When the location information is not included in the emergency request, or additional location information is required, the E-CSCF can request the LRF to retrieve location information. The LRF returns the necessary location/routing information to the IMS network 606. The IMS network 606 uses the routing information returned by the LRF to route the emergency session request to the appropriate PSAP 608 (block 620).

Then the emergency session and bearer resources establishment are completed with the PSAP 608 (block 622). Thus, when IMS emergency registration is performed, the UE 602 initiates the IMS emergency session establishment using the IMS session establishment procedures containing an emergency session indication and emergency Public User Identifiers. Otherwise, the UE 602 initiates the IMS emergency session establishment using the IMS session establishment procedures containing an emergency session indication and any registered Public User Identifier.

With the emergency call session established, the PSAP 608 captures sufficient information about the emergency caller (UE 602) for purposes such as being able to call back (block 624). Thus, the PSAP 608 is prepared should the emergency session be interrupted or released (block 626). The PSAP 608 can initiate an emergency callback (block 628). The emergency callback bears identification as an emergency call in its establishing communications (block 630) and labels the call as an emergency or emergency callback (block 632) or by the call being self-identified as originating from an emergency center/PSAP (block 634).

After or during the emergency callback session being established with the UE 602, the UE 602 detects the emergency status of the call (block 636). The UE 602 performs priority handling, such as placing on hold or dropping any second sessions to free up capacity and remove user distractions (block 638). Further, the UE 602 can prevent further impediments by disabling features that would obscure or distract from the emergency call, such as disabling call waiting, three-way calling, multimedia streaming/playback sessions, device silencing/sleep mode, etc. (block 640). The UE 602 performs a user alert, such as a visual, audible, and tactile alert (block 642). In some embodiments, a subset of the network elements in the telecommunication network (e.g., 504 as shown in FIG. 5) can be configured to detect the emergency status of the call and prioritize the call for the UE 602. For example, the subset of the network elements can prevent impediments by disabling features on the UE 602 such as preventing access to certain network features such as multimedia streaming/playback sessions. Additionally or alternatively, the network elements can prioritize network access to the UE 602 over other devices during an emergency callback.

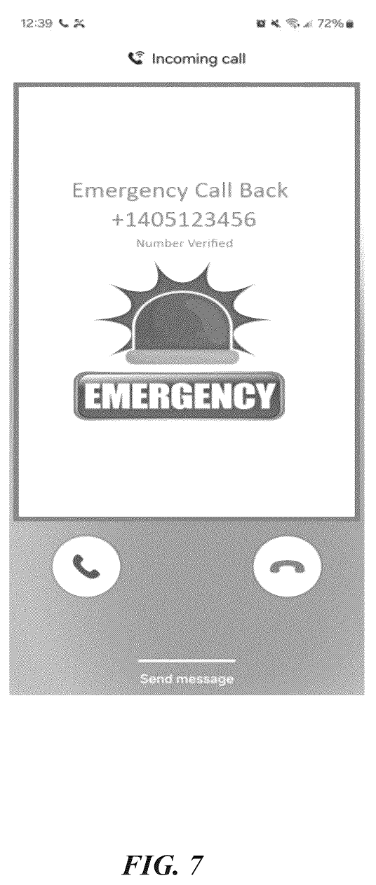

FIG. 7 illustrates an example display of a verified callback on a user device in accordance with one or more embodiments of the present technology. In this example, enhanced caller ID information, such as the reason for calling (e.g., “Emergency Call Back”), the verification information (e.g., “Number Verified”), and the PSAP logo, can be displayed on the user device to increase the chances of the originating caller answering the callback. In some embodiments, the PSAP logo can be provided by the PSAP directly from the SIP INVITE or indirectly through a repository referenced by the PSAP from the SIP INVITE. In some other embodiments, the PSAP logo is provided by the user device when the user device recognizes that the callback is a legitimate PSAP callback.

Referring back to FIG. 5, in some embodiments, the system can cause the home network of the originating caller 502 to suppress certain telephony services temporarily. For example, the system can suppress call waiting, call holding, or call forwarding functionality on the device of the originating caller 502. By limiting these telephony services, the system can allow the PSAP callback to stay uninterrupted during the duration of the callback. The prioritizing handling of the emergency calls can be performed by the home network and/or intermediate/transit networks. The home network and/or intermediate/transit networks can prioritize resource allocation for the emergency callbackon the network over other types of calls or data usage, such as multimedia streaming or video game downloads.

In some embodiments, the system can cause the device of the originating caller 502 to have additional logic or code that temporarily suppresses any new outgoing or incoming calls while the PSAP callback is occurring. The system can initiate the temporary suppression when the PSAP callback is initiated. The system can also initiate the temporary suppression when the original call to the PSAP 506 is disconnected. In this example, the system can prevent the wireless device of the originating caller 502 from receiving or making calls except those to or from the PSAP 506 for a predetermined amount of time. The predetermined amount of time can be a time period, such as one minute, five minutes, or ten minutes.

In yet another example, the originating caller 502 originally contacted the PSAP 506 using a barred or suspended device. A barred or suspended device is a device that is not currently subscribed to the telecommunication network 504. Suspended devices are typically incapable of receiving phone calls and are only capable of calling the PSAP 506 or a network provider. The system can add logic to the suspended device during the original call to allow the suspended device to receive a PSAP callback.

In some other embodiments, the suspended device of the originating caller 502 differentiates verified PSAP callbacks from other incoming calls on the suspended device. The suspended device detects the existence of a verified PSAP callback on the suspended device. The suspended device allows the PSAP callback to proceed so as to be answered by the originating caller 502. This allows the originating caller 502 to receive the PSAP callback even BAIC and/or other suspended telecommunications services are activated on the suspended device.

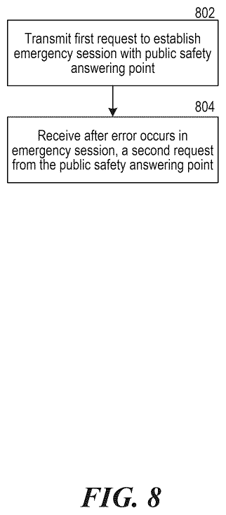

FIG. 8 illustrates a flowchart of a process 800 for emergency callbacks performed by the system. In one example, the system includes at least one hardware processor and at least one non-transitory memory storing instructions, which, when executed by the at least one hardware processor, cause the wireless device to perform the process 800.

At step 802, the system transmits, by a user device, a first request to establish an emergency session with a PSAP. At step 804, the system receives, by a user device, after an error occurs in the emergency session, a second request from the PSAP. The second request is configured to initiate an emergency callback session with the user device in response to the error. The second request selectively comprises information about the PSAP based on whether an identity of the PSAP has been successfully verified by a home network of the user device. In one example, the second request comprises a priority header having a value of “psap-callback.” In another example, the system receives, by the user device, configuration information to initiate a suppression of one or more telephony services during the emergency callback session.

In one example, the identity of the PSAP is verified using a Signature-based Handling of Asserted information using toKENS (SHAKEN) framework. In another example, the second request comprises verification information about the PSAP indicating that the PSAP is valid. In another example, the verification information comprises at least one of: a name of the PSAP, a reason for the request, or one or more caller verification flags. In yet another example, the system displays, by the user device, verification information about the request on a user interface of the user device.

### Computer System

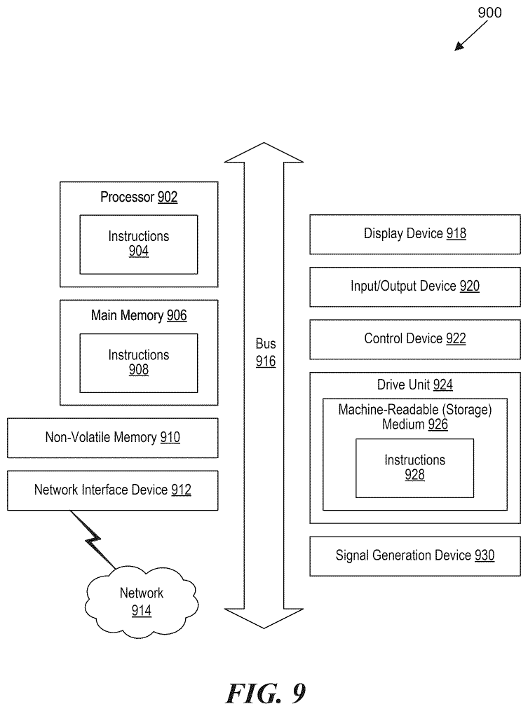

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A system comprising:
a gateway node configured to receive a request from a public safety answering point,
wherein the request is configured to initiate an emergency callback session with a user device in response to an error occurring in an emergency session between the user device and the public safety answering point;
a home network node configured to provide, upon an identity of the public safety answering point being verified, verification information about the request and the public safety answering point to the user device; and
a module deployed on a user device, the module comprising at least one processor and at least one non-transitory memory storing instructions,
wherein the instructions, when executed by the at least one processor, cause the module to display the verification information about the request on a user interface of the user device.

2. The system of claim 1, wherein the identity of the public safety answering point is verified using a Signature-based Handling of Asserted information using toKENS (SHAKEN) framework.

3. The system of claim 1, wherein the request comprises a priority header having a value of “psap-callback.”

4. The system of claim 1, wherein the verification information about the request comprises at least one of:
a name of the public safety answering point,
a reason for the request,
an emergency logo, or
one or more caller verification flags.

5. The system of claim 1, wherein the home network node is configured to provide configuration information to initiate a suppression of one or more telephony or supplementary services during the emergency callback session.

6. The system of claim 5, wherein the one or more telephony services comprise at least one of: call waiting, call holding, call forwarding, call barring, or call transferring.

7. The system of claim 5, wherein the one or more telephony services comprise an incoming call to the user device or an outgoing call from the user device.

8. The system of claim 5, wherein the configuration information indicates a time duration for the suppression of the one or more telephony services.

9. A method for performing an emergency callback, comprising:
transmitting, by a user device, a first request to establish an emergency session with a public safety answering point; and
receiving, by the user device, after an error occurs in the emergency session, a second request from the public safety answering point,
wherein the second request is configured to initiate an emergency callback session with the user device in response to the error,
wherein the second request selectively comprises information about the public safety answering point based on whether an identity of the public safety answering point has been successfully verified by a home network of the user device.

10. The method of claim 9, wherein the identity of the public safety answering point is verified using a Signature-based Handling of Asserted information using toKENS (SHAKEN) framework.

11. The method of claim 9, wherein the second request comprises verification information about the public safety answering point indicating that the public safety answering point is valid.

12. The method of claim 11, wherein the verification information comprises at least one of:
a name of the public safety answering point,
a reason for the second request,
a logo, or
one or more caller verification flags.

13. The method of claim 11, comprising:
displaying, by the user device, verification information about the second request on a user interface of the user device.

14. The method of claim 9, wherein the second request comprises a priority header having a value of “psap-callback.”

15. The method of claim 9, comprising:
receiving, by the user device, configuration information to initiate a suppression of one or more telephony services during the emergency callback session.

16. A non-transitory, computer-readable storage medium comprising instructions recorded thereon, wherein the instructions, when executed by at least one data processor of a system, cause the system to:
transmit, by a user device, a first request to establish an emergency session with a public safety answering point; and
receive, by the user device, after an error occurs in the emergency session, a second request from the public safety answering point,
wherein the second request is configured to initiate an emergency callback session with the user device in response to the error,
wherein the second request selectively comprises information about the public safety answering point based on whether an identity of the public safety answering point has been successfully verified by a home network of the user device.

17. The non-transitory, computer-readable storage medium of claim 16, wherein the identity of the public safety answering point is verified using a Signature-based Handling of Asserted information using toKENS (SHAKEN) framework.

18. The non-transitory, computer-readable storage medium of claim 16, wherein the second request comprises verification information about the public safety answering point indicating that the public safety answering point is valid that includes:
a name of the public safety answering point,
a reason for the second request, or
one or more caller verification flags.

19. The non-transitory, computer-readable storage medium of claim 18, wherein the instructions further cause the system to:
display, by the user device, verification information about the second request on a user interface of the user device.

20. The non-transitory, computer-readable storage medium of claim 16, wherein the instructions further cause the system to:
receive, by the user device, configuration information to initiate a suppression of one or more telephony services during the emergency callback session.
